(19) United States
(12) Patent Application Publication
(10) Pub. No.: US 2010/0232896 A1
(43) Pub. Date: Sep. 16, 2010

(54) DRILL PRESS

(76) Inventors: Warren Brown, Victoria (AU); Graham Gerhardt, Victoria (AU); Harry Szommer, Victoria (AU)

Correspondence Address: HOWARD & HOWARD ATTORNEYS PLLC, 450 West Fourth Street, Royal Oak, MI, 48067, US

(21) Appl. No.: 12/676,330

(22) PCT Filed: Sep. 3, 2008
(86) PCT No.: PCT/CN2008/072247

§ 371 Date: May 27, 2010

(30) Foreign Application Priority Data
Sep. 3, 2007 (CN) 200710131783.7

(51) Int. Cl. B23B 47/00; B23Q 1/26; B23Q 1/66

(52) U.S. Cl. 408/91; 408/136

(57) ABSTRACT

A drill press including a base, a column mounted on the base, and a head assembly connected to the column. Wherein the head assembly includes a power device and a drill bit rotatably driven by the power device, the drill press further includes first and second worktables, and a changeover mechanism disposed between the first and the second worktables for selectively securing the first or second worktable located at working position. The changeover mechanism can alternatively rapidly adjust the first and the second worktables to working position so as to permit the operator to select either the first worktable or the second worktable according to the shape of workpiece, saving the trouble of a special tooling disassembly.

### TECHNICAL FIELD

The present invention relates to a drill press, and more specifically, to a new type drill press.

### BACKGROUND OF THE INVENTION

The drill press is one of commonly used machining equipment. A drill press in existing art mainly includes a base, a column set on the base, a worktable for placing the workpiece and a headstock, wherein the headstock is mainly composed of a motor, a driving gear, a spindle and a drill bit mounted on the spindle. When the motor rotates, the spindle is driven to move by a driving gear so as to further realize drilling machining. The worktable is a plane. When a cylindrical workpiece is machined, a special V-shaped tooling has to be used to support the workpiece; when a non-cylindrical workpiece is machined, the special clamp has to be removed. Therefore, the operation is very inconvenient. For instance, a drill press as disclosed by the U.S. Pat. No. 5,318,392, is provided with a conventional worktable and a fence assembly slide-connected on a column. When machining a cylindrical workpiece, a special V-shaped tooling is fitted onto the fence assembly and the piece is clamped by conventional pliers; while machining a rectangular workpiece, the special V-shaped tooling has to be removed if not drilling on a special surface. This shows the conventional drill press is inconvenient, strenuous and time-consuming during operation and application.

### SUMMARY OF THE INVENTION

The present invention mainly aims at providing a drill press convenient, time-saving and least-resistant in operation and without the need of disassembling special tooling.

The beneficial effects of the present invention are as follows: a rapid position-changing device between the first and the second worktables permits that the first or the second worktable can alternatively support a workpiece and be adjusted to working position. Moreover, one is a V-shaped worktable and the other is a conventional worktable; in this way, if the workpiece to be machined is cylindrical, the rapid location-changing device is used to make V-shaped worktable function as supporting plane to support the workpiece without the V-shaped tooling to be assembled; in addition, a slot is configured in the middle of the V-shaped worktable so as to support rectangular workpiece; the V-shaped worktable is not suitable for supporting a big-sized workpiece, but rapid position-changing device can be used to permit the conventional worktable to support it. Hence, the exemption from V-shaped tooling assembly makes the operator's manipulation convenient, time-saving and least-resistant.

### BRIEF DESCRIPTION OF THE DRAWINGS

The present invention is further detailed in combination with the drawings and the embodiments hereinafter.

FIG. 1 is a stereoview of Embodiment 1 for the drill press of the present invention (the first worktable as supporting plane).

FIG. 2 is a partially exploded view of Embodiment 1 for the drill press of the present invention.

FIG. 3a is a partially sectional view of Embodiment 1 for the drill press of the present invention.

FIG. 3b is a partially sectional view after the column in FIG. 3a rotates by 180°.

FIG. 4 is a sectional view of the lifting device and the first positioning device in Embodiment 1 for the drill press of the present invention.

FIG. 5 is the sectional view of the clamping mechanism in Embodiment 1 for the drill press of the present invention.

FIG. 6 is a stereoview of Embodiment 1 for the drill press of the present invention (the second worktable as supporting plane).

FIG. 7 is a stereoview of Embodiment 1 for the drill press of the present invention (the second worktable as supporting plane).

FIG. 8 is a stereoview of Embodiment 1 for the drill press of the present invention (the second worktable as supporting plane).

FIG. 9 is a rear view of Embodiment 2 for the drill press of the present invention.

FIG. 10 is a partially exploded view of Embodiment 2 for the drill press of the present invention.

FIG. 11a is a cross-sectional view of the first positioning device in Embodiment 2 for the drill press of the present invention (machine tool bracket is positioned relative to the column at this time).

FIG. 11b is a cross-sectional view of the first positioning device in Embodiment 2 for the drill press of the present invention (machine tool bracket can freely rotate relative to the column at this time).

FIG. 12 is a stereoview of the positioning handle in Embodiment 2 for the drill press of the present invention.

FIG. 13 is the stereoview of the clamping mechanism in Embodiment 2 for the drill press of the present invention.

FIG. 14 is a stereoview of Embodiment 2 for the drill press of the present invention (no the first worktable, and the worktable bracket can freely rotate relative to machine tool bracket).

FIG. 15 is a stereoview of Embodiment 2 for the drill press of the present invention (no the first worktable, and the first worktable is in the vertical working position).

FIG. 16 is a stereoview of Embodiment 2 for the drill press of the present invention (the first worktable as supporting plane).

FIG. 17 is a stereoview of Embodiment 2 for the drill press of the present invention (the first worktable as supporting plane).

FIG. 18 is a stereoview of Embodiment 2 for the drill press of the present invention (the second worktable as supporting plane).

FIG. 19 is a stereoview of Embodiment 3 for the drill press of the present invention (the first worktable as supporting plane).

FIG. 20 is a stereoview of Embodiment 3 for the drill press of the present invention (the second worktable as supporting plane).

FIG. 21 is a stereoview of Embodiment 4 for the drill press of the present invention.

FIG. 22 is a stereoview of Embodiment 5 for the drill press of the present invention.

### DETAILED DESCRIPTION OF THE EMBODIMENTS

The Specification discloses five embodiments to realize the purpose of the present invention according to the invention concept.

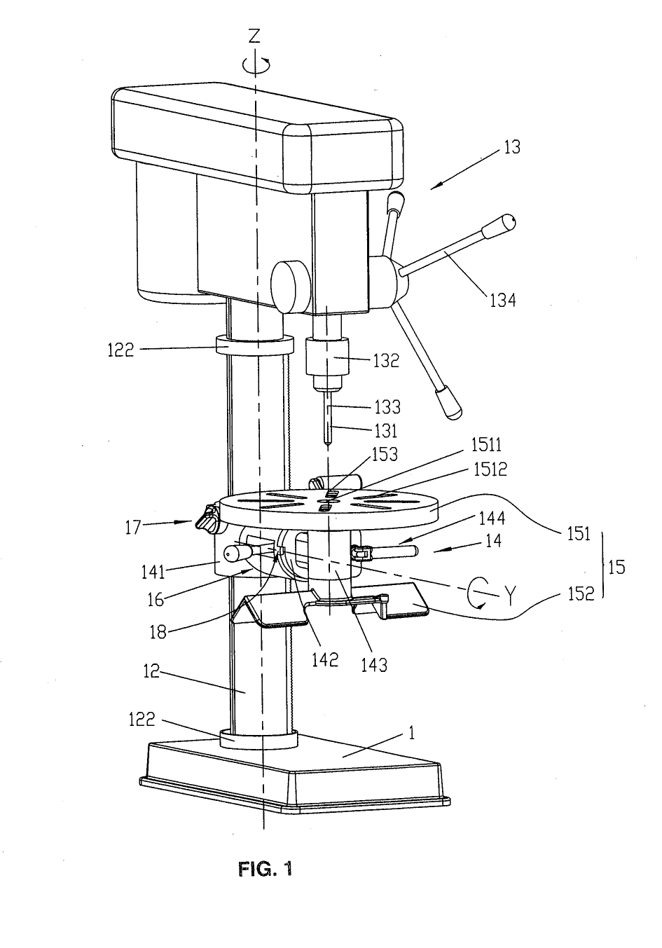

As shown in FIG. 1, a drill press, comprising a base 1, a column 12 conjugated with the base 1 and extended along Axis Z, a headstock 13 conjugated above the column 12, wherein the headstock 13 includes a power device (indicate motor in this embodiment, not shown in the figure) and a rotating drill chuck 132, the drill chuck 132 is used to clamp the drill bit 131 or other fitting work head, and the drill chuck 132 and drill bit 131 can make up-down movement relative to the central axis 133 by operating the handle 314, while the driving structure inside the headstock 13 is the same as the conventional drill press, so it is unnecessary to go into details.

A worktable assembly 15 is conjugated approximately in the middle of the column 12. The worktable assembly 15 includes the first and the second worktable 151, 152, wherein the first worktable 151 is conventional worktable, mainly for supporting common workpiece; the second worktable 152 is V-shaped worktable, mainly for supporting cylindrical workpiece. The second worktable 152 can be also designed to other shape according to the workpiece profile.

The drill press further comprises a rapid position-changing device 14, wherein the rapid position-changing device 14 can alternatively rapidly adjust the first and the second worktables 151, 152 to working position so as to permit the operator to select either the first worktable 151 or the second worktable 152 according to the shape of workpiece, saving the trouble of a special tooling disassembly. The rapid position-changing device 14 mainly includes a machine tool bracket 141 movably conjugated on the column 12, a worktable bracket 142 set on the machine tool bracket 141 and extended along Axis Y perpendicular to Axis Z, and a binding post 143 connecting the first and the second worktables, wherein the worktable bracket 142 rotates around Axis Y relative to the machine tool bracket 141, the first and the second worktables 151, 152 are connected with the worktable bracket 142 through the binding post 143, and a fixing device 144 is set between them. In this embodiment, the first and the second worktables 151, 152 are in 180° layout relative to Axis Y and linked via the binding post 143. The symmetrical distribution of the two worktables relative to Axis Y disclosed in the embodiment is only a preferred solution. The design of several worktables for conveniently machining different workpieces come up by the technicians skilled in this art is also within the concept of the present invention.

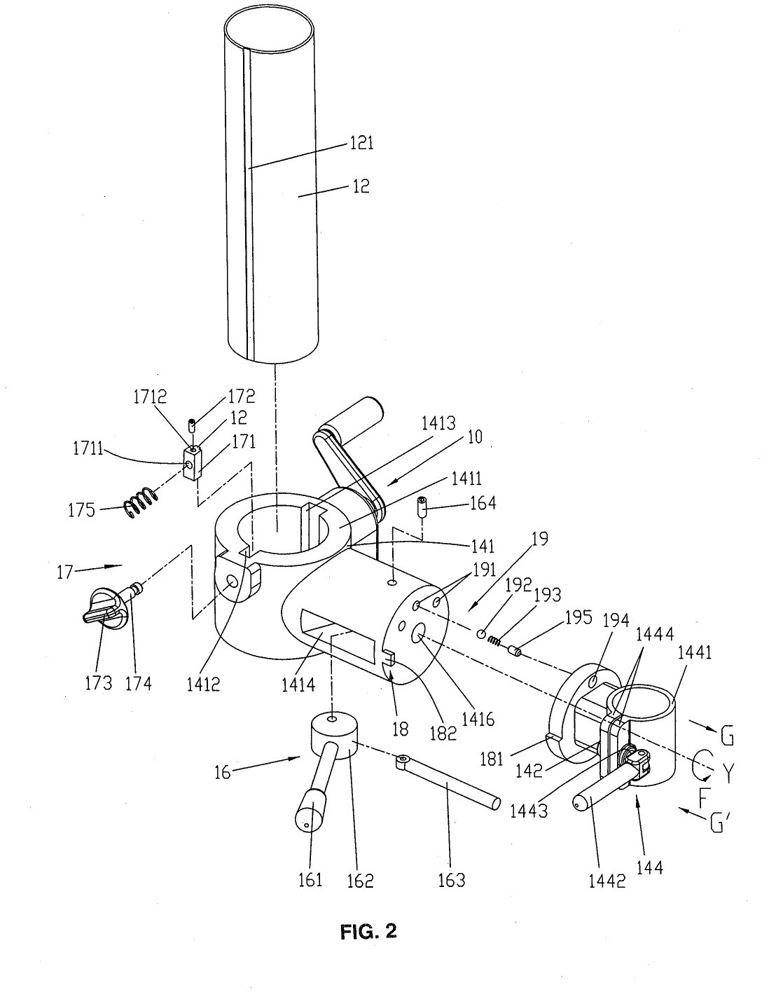

As shown in FIG. 2, the machine tool bracket 141 includes a bushing 1411 for containing the column 12, wherein the inner diameter of the bushing 1411 is slightly more than the diameter of the column 12 so that the machine tool bracket 141 can both rotate and slide, up and down relative to the column 12. For easily adjusting the height of the machine tool bracket 141 relative to the column 12, a lifting device 10 is set between them.

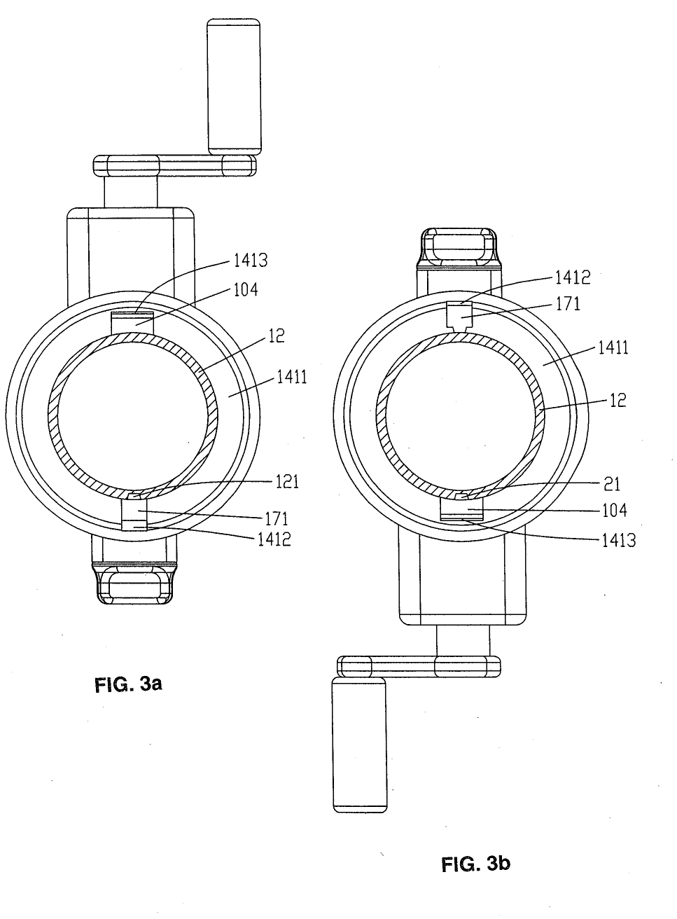

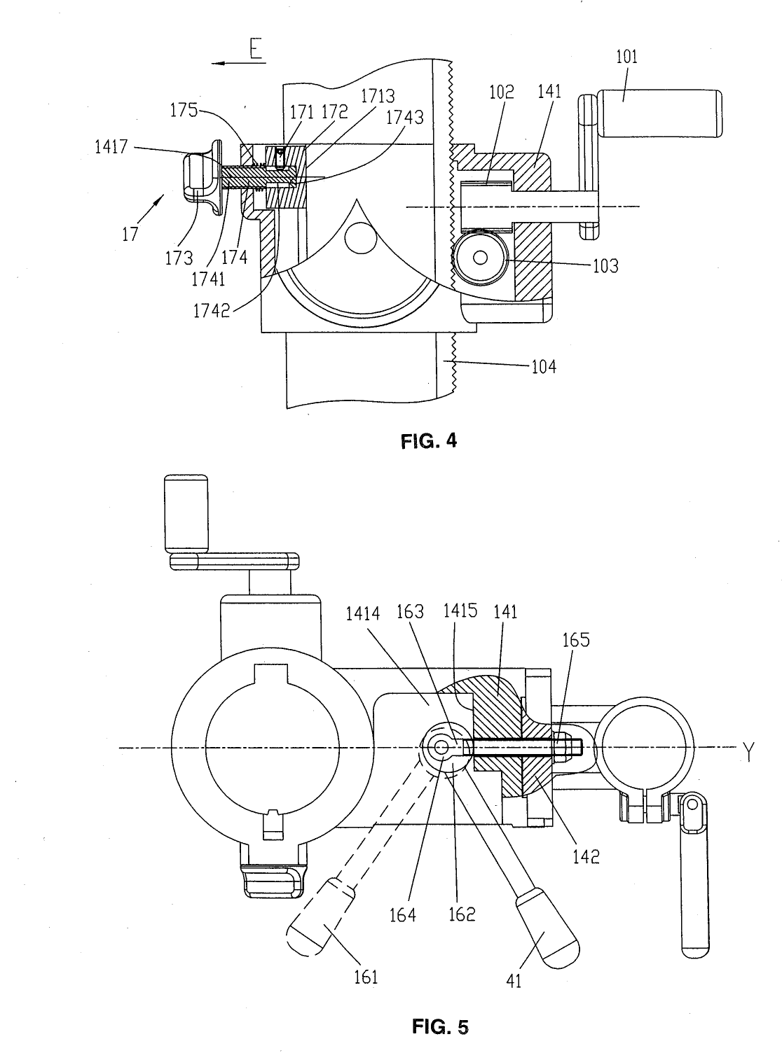

As shown in FIG. 4, the lifting device 10 includes a lifting handle 101 pivoted on the machine tool bracket 141, a worm 102 conjugated with it, a worm wheel 103 pivoted on the machine tool bracket 141 and a rack 104 movably set on the column 12, wherein the worm wheel 103 is engaged with the worm 102 and the rack 104 simultaneously. Since the worm wheel 103 and the worm 102 can be self-locked, the lifting handle 101 is not operated, and the machine tool bracket 141 may not make the up-down movement relative to the column 12. When adjusting the height of the machine tool bracket 141 relative to the column 12, operate the lifting handle 101 to enable it to drive the worm 102 for rotation, thus the worm 102 is engaged with the worm wheel 103 which (the worm wheel 103) is further engaged with the rack 104 so that the machine tool bracket 141 slides relative to the column 12. As shown in FIG. 3a, the machine tool bracket 141 is fitted with the first and the second grooves 1412, 1413, wherein the second groove 1413 is used to contain the rack 104. Two upper and lower stop rings 122 are configured on the column 12 to allow the rack 104 to rotate relative to Axis Z (as shown in FIG. 1), but incapable of moving along Axis Z. As shown in FIG. 3b, the machine tool bracket 141 rotates by 180°, and the rotation of the machine tool bracket 141 drives the rack to revolve together.

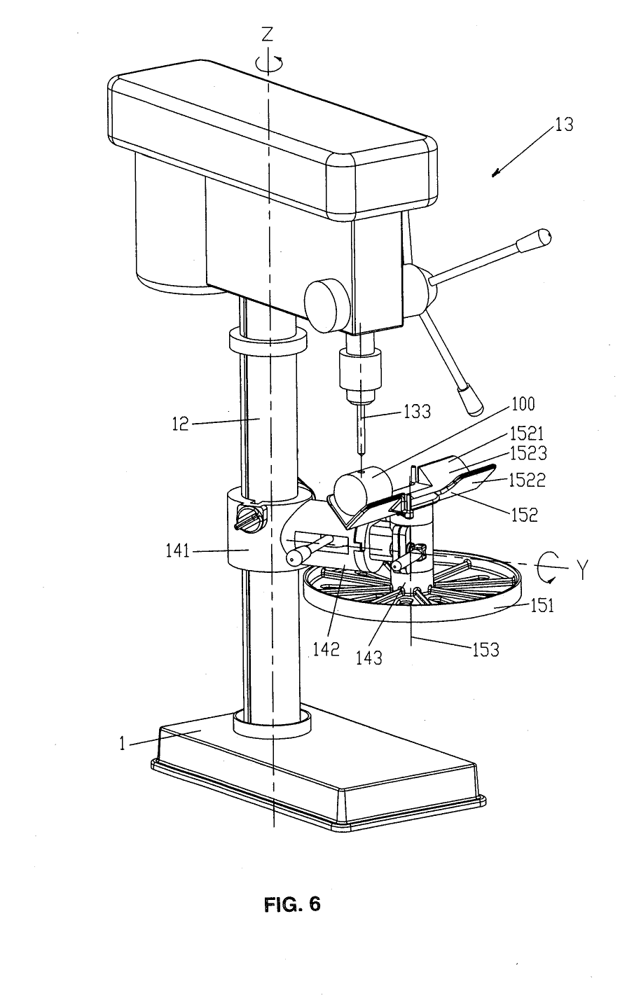

The machine tool bracket 141 can rotate around Axis Z relative to the column 12. However, the central axes of the worktable 153 after rotation is prone to deviate from the axis of the drill bit 133 (as shown in FIG. 6). Therefore, the first positioning device 17 is mounted between the machine tool bracket 141 and the column 12. As shown in FIGS. 2 and 4, the first positioning device 17 includes the first position part 171 movably set on the machine tool bracket 141 and a positioning slot 121 fixedly set on the column 12, wherein the first positioning part moves between positioning slot 121 location containing it and the positioning slot 121 location deviating from it. The first positioning part 171 is a convex block, wherein its wide end is contained in the first groove 1412 of the machine tool bracket 141, and its narrow end can be alternatively housed in the positioning slot 121. The first groove 1412 has a vertical axis 1417 and the first positioning part 171 can move along the vertical axis 1417.

The first and the second positioning holes 1711, 1712 are set on the first positioning piece 171. The positioning post 173 is fixedly connected onto the positioning part 171 through the second positioning hole 1712.

For convenient operation, the first positioning device 17 further includes a releasing device for enabling the first positioning part 171 to move along the vertical axis 1417 and move between positioning slot 121 location containing it and the positioning slot 121 location deviating from it. The releasing device includes a positioning handle and a spring 175 set between the positioning handle and the first positioning part 171. In this embodiment, the positioning handle is the button 173, a connecting axis 174 is fixedly conjugated on the button 173, the first spring 175 is sleeved around the connecting axis 174, wherein the connecting axis 174 is a step axis consisting of the first end 1741 of the connecting button 173, the axis end 1743 fit for the first positioning part 171 and the axis neck 1742 between them and close to the axis end 1743. Moreover, on the first end 1741, thread fit for the thread hole in the machine tool bracket 141 is provided. The connecting axis 174 is also coordinated with the first positioning part 171 through the thread hole of the machine tool bracket 141 and the first positioning hole 1711 of the first positioning part 171; the positioning post 173 is located at the axis neck 1742; the first spring 175 is situated in the first groove 1412 of the machine tool bracket 141, wherein one end props up the inner wall of the first groove 1412 and the other end holds out against the first positioning part 171.

As shown in FIG. 4, under the action of the spring force, the narrow end of the first positioning part 171 is contained in the positioning slot 121. Then the button 173 is tightened so that the outer surface 1713 of the narrow end of the first positioning part 171 is closely contacted with the surface of the machine tool bracket 141, thus the machine tool bracket 141 is fixed relative to the column 12 and the central axis 153 of the worktable is aligned with the axis 133 of the drill bit (as shown in FIG. 1). If and when the machine tool bracket 141 drives the worktable assembly 15 to rotate relative to the column 12 for machining demand, release the button 173 in reverse direction so that it moves along direction E and the axis end 1743 contacts the positioning post 173, thus to drive the positioning column 173 to move along direction E together, since the first positioning part 171 is fixedly connected with the positioning post 173, the first positioning part 171 is also driven to move along direction E together, thus to further compress the first spring 175 and enable the narrow end of the first positioning part 171 deviates from the positioning slot 121, namely, the outer surface 1713 of the narrow end and the surface of the machine tool bracket 141 become loose. In this way, the machine tool bracket 141 can freely rotate relative to the column 12 (as shown in FIG. 6).

A clamping mechanism 16 for fixing the relative location of the worktable bracket and the machine tool bracket is mounted between the machine tool bracket 141 and the worktable bracket 142. As shown in FIGS. 2 and 5, the clamping mechanism 16 includes a clamping handle 161 and an eccentric wheel 162 conjugated with it as well as a connecting part 163 conjugated with the eccentric wheel 162, wherein the clamping handle 161 is located on the long slot 1414 of the machine tool bracket 141; the eccentric wheel 162 is pivoted onto the machine tool bracket 141 through pin 164, and the eccentric wheel 162 is alternatively coordinated with the inner wall 1415 of the long slot 1414; one end of the connecting part 163 is provided with a hole fit for the pin 164, the connecting part 163 is conjugated with the eccentric wheel 162 through the coordination of the hole and the pin 164, the other end of the connecting part 163 is provided with the thread fit for the nut 165, and the connecting part 163 is engaged with the nut 165 through the central hole 1416 of the machine tool bracket and the central hole of the worktable bracket (not shown in the figure), thus the worktable bracket 142 can drive the first and the second worktables 151, 152 to rotate around Axis Y relative to the machine tool bracket 141. When the eccentric wheel 162 and the inner wall 1415 of the long slot are closely fitted to each other in the first location, the worktable bracket 142 and the machine tool bracket 141 are fixedly connected together and cannot make relative movement; when the rotary clamping handle 161 (broken line location shown in FIG. 6) is in the second location, a clearance appears between the eccentric wheel 162 and the inner wall 1415 of the long slot, thus a clearance also occurs between the worktable bracket 142 and machine tool bracket 141, in this way, the worktable bracket 142 can freely rotate around Axis Y relative to machine tool bracket 141.

The worktable bracket 142 freely rotates around Axis Y relative to machine tool bracket 141. In this way, the first worktable 151 and the second worktable 152 can support a workpiece in any location, but the horizontal location is most commonly used (similar to 0 degree). Therefore, the second positioning device 18 is set between the machine tool bracket 141 and worktable bracket 142. As shown in FIG. 2, the second positioning device 18 includes the first stop block 181 and the second stop block 182, wherein the first stop block can be set on either the machine tool bracket 141 or the worktable bracket 142, the second stop block can be set on either the machine tool bracket 141 or the worktable bracket 142, and the first stop block moves between the location fit for the second stop block and the location deviating from the second stop block.

In this embodiment, two second stop blocks 181 (only one displayed) are symmetrically set on the worktable bracket 142, the second stop blocks 182 are fixed and set on the machine tool bracket 141, wherein the angle included by the first stop blocks 182 is 180° and the first stop block 182 alternatively fits for the second stop block 181 with the rotation of the worktable bracket 142. The coordination of the first stop block 181 respectively with the second stop block 182 can realize the respective horizontal location of the first worktable 151 and the second worktable 152. In this embodiment, the second stop block 182 is the upper projecting block of the machine tool bracket 141, and two symmetrically mounted first stop blocks 181 are the protruding contact face of the worktable bracket 142. In this embodiment, since the second stop block 182 is set on the machine tool bracket 141, both the first worktable 151 and the second worktable 152 can rotate 180° but not 360°, as shown in FIG. 2, the worktable assembly 15 can rotate around Axis Y along Direction F only.

During utilization, the operator may also need to machine some inclined holes and require some special angles such as 15°, 30° or 45° (show ±45° and 0° only in FIG. 2) The drill press also has an auxiliary positioning device 19 between the machine tool bracket 141 and the worktable bracket 142, wherein the auxiliary positioning device 19 includes several positioning holes 191 set on the machine tool bracket 141, the steel balls 192 fit for the positioning hole 191 and a second spring 193. A housing slot 194 is set on the worktable bracket 142. Through screw stud 195, the steel ball 712 and the second spring 713 are contained in the housing slot 194. When rotating the worktable bracket 142, the steel ball 192 and positioning hole 191 are fitted each other to confirm special angle, and under the force applied, steel ball 192 may also deviate automatically and then coordinate with the positioning hole 191 so that the worktable bracket 142 can also freely rotate.

If not needed for special angles, the scale indication device similar to that used on the conventional drill press may be used (not shown in the figure).

A fixing device 144 is configured between the binding post 143 and the worktable bracket 142. As shown in FIG. 2, the fixing device 144 includes a retainer ring 1441 for housing the binding post 143, a fixing handle 1442 pivoted on the retainer ring 1441 and a screw stud 1443, wherein the retainer ring 1441 in a non-cylindrical shape is provided with a pair of lugs 1444 extending outwards and with clearance, thus the retainer ring 1441 has a certain elasticity; a thread hole fit for the screw stud 1443 is set on one lug (not shown in the figure); a through hole housing the screw stud 1443 is mounted on the other lug (not shown in the figure). For fixing the worktable, tighten the fixing handle 1442 so that the screw stud 1443 is driven to move along Direction G′, thus the clearance is reduced and the spacing between the retainer ring 1441 and the binding post 143 becomes increasingly close; in this way the worktable may be fixed and not rotate relative to the central axis 153 (as shown in FIG. 1); for making the worktable rotate around the central axis 153 (as shown in FIG. 1), release the fixing handle 1442 by screwing in the reverse direction so that the screw stud 1443 is driven to rotate along Direction G, thus the clearance increases and the retainer ring 1441 may also automatically restore to the original state, in this way the retainer ring 1441 and binding post 143 become loose relatively, so the worktable can rotate relative to the central axis 153. In a loose condition, the relative height between the worktable and the worktable bracket 142 may also be adjusted.

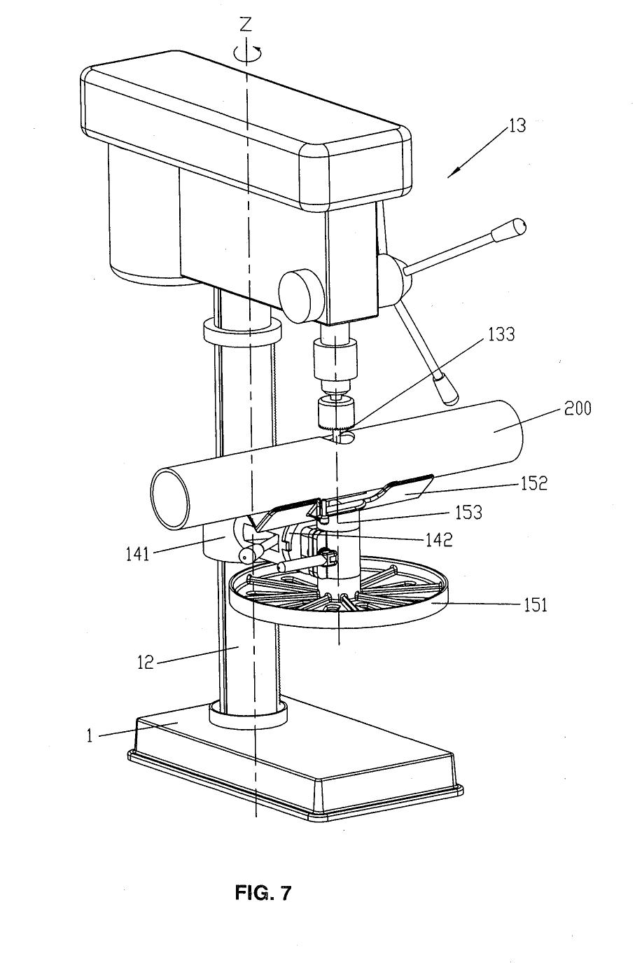

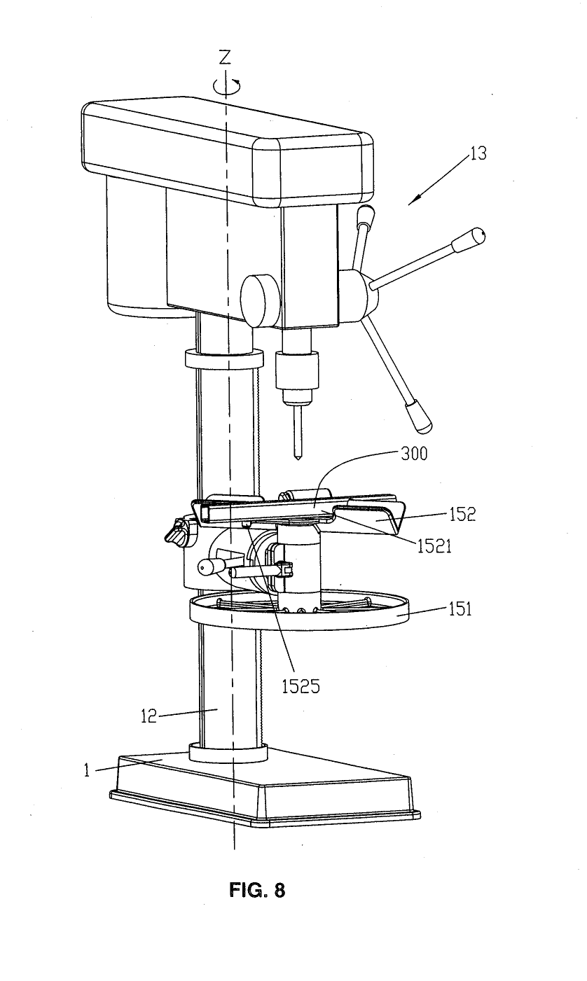

Referring to FIG. 1 again, the worktable for supporting the workpiece is the conventional first worktable 151 on which a containing hole 1511 for containing the drill bit 131 and some technical slots 1512 for containing special tooling are provided. The operator may select special tooling desired for operation. As shown in FIG. 6, the worktable for supporting the workpiece is V-shaped second worktable 152 which has the first and the second sides 1522, 1523 as well as the containing space 1524 formed by the two sides, wherein the containing space 1524 is mainly used for supporting cylindrical workpiece, so special V-shaped tooling is not required when machining short cylindrical workpiece 100. It is only required to rotate the worktable relative to Axis Y in order to make the second worktable 152 function as the workpiece supporting surface. When machining vertical holes, the second position device 18 can be utilized to make the second stop blocks 182 and the first stop blocks 181 fit for each other and the second worktable 152 up to horizontal location. When machining inclined holes, the above steps can be also referred to, namely, the auxiliary positioning device 19 is used to realize special angle, but for no special angle, the scale indication device (not shown in the figure) identical to that on the conventional drill press can be used for realization. As shown in FIG. 6, the workpiece 100 is short and cylindrical and can be positioned on one end of the second worktable 152, so the machine tool bracket 141 can rotate to make the central hole to be machined align with the central axis 133 of the drill bit. Alternatively, the workpiece 100 can be positioned in the middle of the second worktable 152 (not shown in the figure), thus the machine tool bracket 141 is not required to rotate. FIG. 7 shows the second worktable 152 is used to support the longer cylindrical workpiece 200 for machining, wherein the worktable can position the center of the workpiece 200 approximately in the central axis 153 of the worktable, thus the machine tool bracket 141 is not required to rotate. As shown in FIG. 8, the second worktable 152 is provided with a slot 1521 for containing the workpiece symmetrically set in the middle of the first and second sides 1522, 1523 approximately, wherein the slot 1521 is mainly used for supporting the workpiece 300 and two positioning pins 1525 (only one shown in the figure) are set on the diagonal location of the slot 1521, the positioning pins 1525 fix the rectangular workpiece more reliably. Therefore, it is only required to rotate the worktable relative to Axis Y to make the first and the second worktables 151, 152 alternatively function as workpiece supporting plane, thus the operator can use the drill press conveniently with time and labor saved, but the disassembly of V-shaped tooling is exempted.

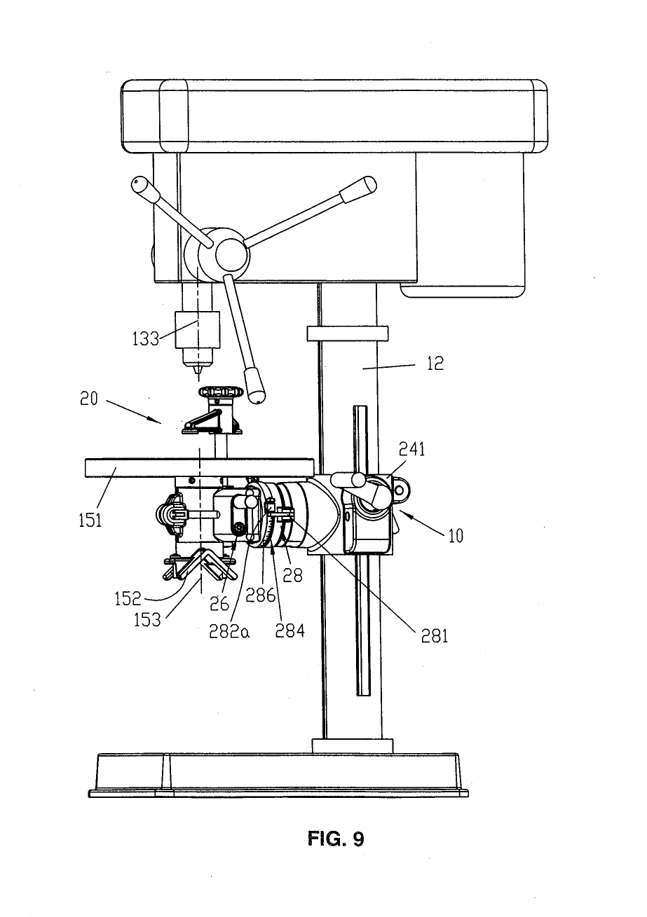

FIG. 9 to FIG. 18 shows the second embodiment of the present invention. There are many components similar to those in Embodiment 1. The components with the same digits as displayed and described in Embodiment 1 are largely similar to those in Embodiment 1 in design, configuration and operation hereinafter; therefore, no further details are given for them. With the reference digits for components heading by “2” similar to those in Embodiment 1, different components are given for different digital identifications. The difference from Embodiment 1 is emphasized hereinafter.

In Embodiment 2, the fixing device set between the machine tool bracket 241 and the column 12 has the same structure as the fixing device 144 between the binding post 143 and the worktable bracket 142 in Embodiment 1; therefore, further details will not be given.

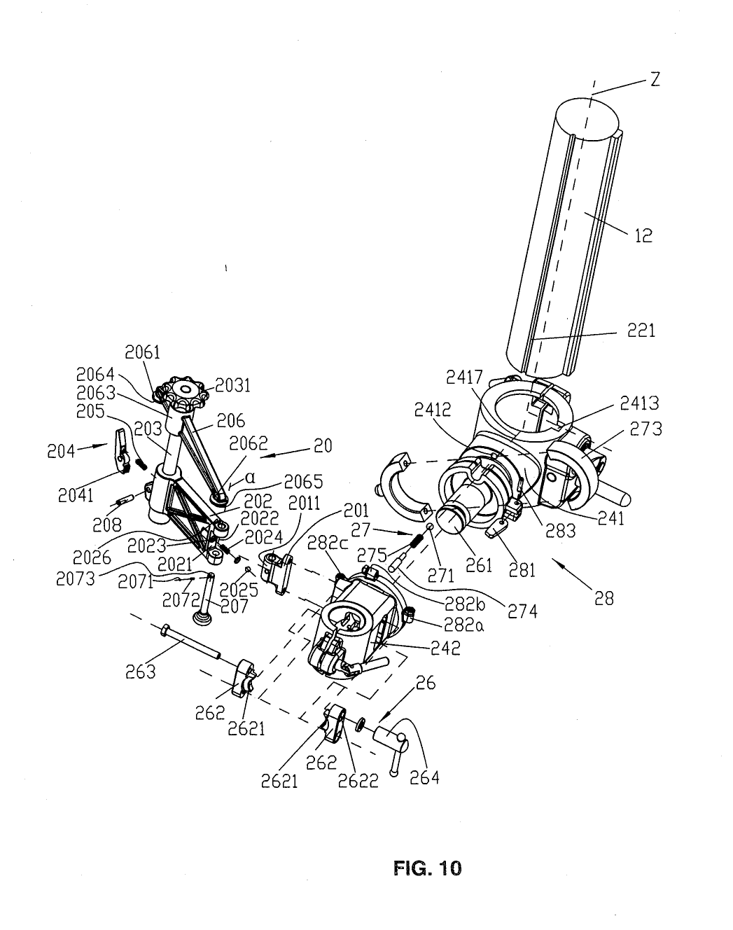

As shown in FIG. 10, a first positioning device 27, which includes the first positioning part 271 movably set on the machine tool bracket 241 and the positioning slot 221 fixedly set on the column 12, is mounted between the machine tool bracket 241 and the column 12, wherein the first positioning part 271 moves between the location for containing the positioning slot 221 and the location deviating from the positioning slot 221. The first positioning part 271 is a steel ball. The first groove 2412 has a vertical axis 2417. The steel ball 271 can move along the vertical axis 2417. In this embodiment, the first and second groove 2412, 2413 are vertically set.

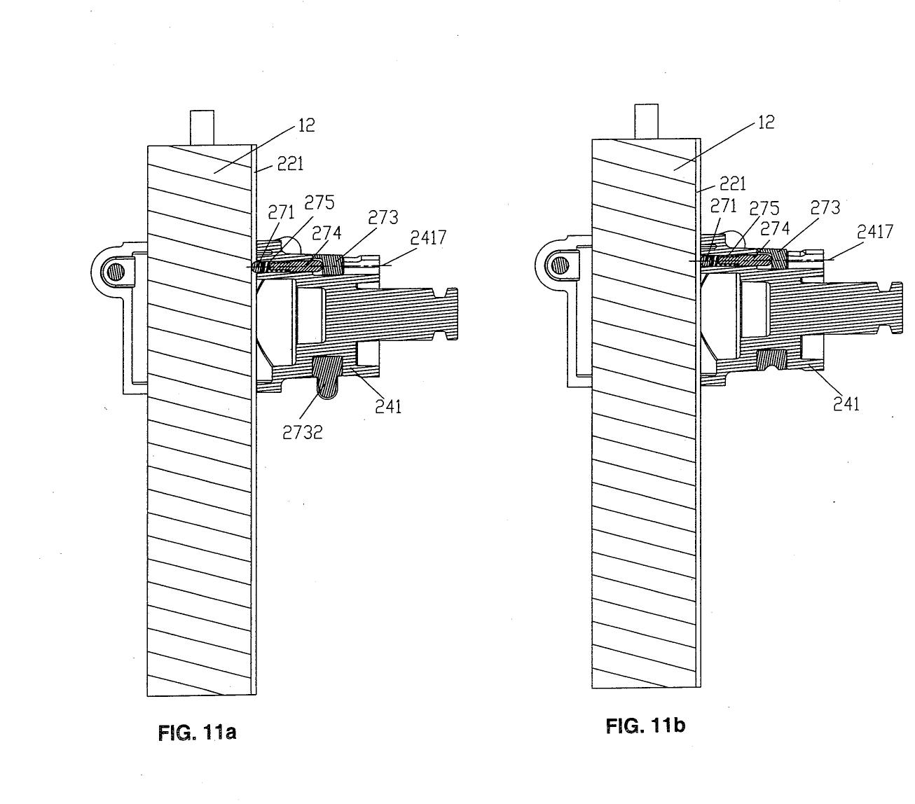

For convenient operation, the first positioning device 27 further includes a releasing device. As shown in FIG. 11a, the releasing device is used to drive the first positioning part 271 to move along the vertical axis 2417 and move between the location for containing the positioning slot 221 and the location deviating from the positioning slot 221. The releasing device consists of a positioning handle 273, positioning pin 274 and a first spring 275 sleeved around the positioning pin 274, wherein the first spring 275 is mounted between the positioning pin 274 and the first positioning part 271.

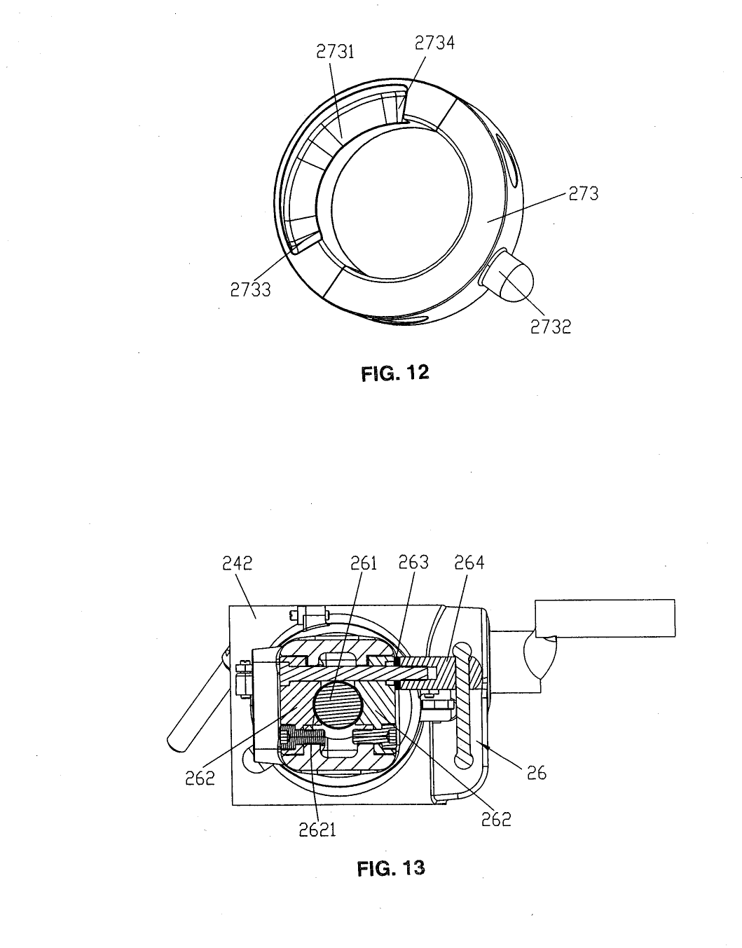

The positioning handle 273 is rotatablely fixed at the machine tool bracket 241. As shown in FIG. 12, it has the inclined plane 2731 set along the end surface and button 2732 for convenient operation. The inclined plane 2731 is a surface with a gradient, wherein the highest points is 2733 and the lowest point is 2734. The rotation of the positioning handle 273 can make the positioning pin 274 slide along the inclined plane 2731. When operating the button 2732 to make the positioning pin 274 slide from the highest point 2733 to the lowest point 2734, the positioning pin 274 may facilitate the first positioning part 271 to slide to the column 12 side along the vertical axis 2717, thus the first positioning part 271 can be contained in the positioning slot 221, as shown in FIG. 11a, the machine tool bracket 241 is fixed relative to the column 12 accordingly, while the central axis 153 of the worktable aligns with the axis 133 of the drill bit (as shown in FIG. 9); when the positioning pin 274 slides from the lowest point 2734 to the highest point 2733, positioning pin 274 may facilitate the first positioning part 271 to slide to the side away from the column 12 along the vertical axis 2717, thus the first positioning part 271 can deviate from the positioning slot 221, so the machine tool bracket 241 can freely rotate relative to the column 12, as shown in FIG. 11b.

As shown in FIGS. 9, 10 and 13, a clamping mechanism 26 for fixing the relative location of worktable bracket and machine tool bracket is set between the machine tool bracket 241 and the worktable bracket 242. As shown in FIGS. 10 and 13, the clamping mechanism 26 includes a bracket shaft 261 on the machine tool bracket 241, fitting parts 262 on the worktable bracket 242 and a locking device, wherein the locking device consists of bolts 263 and a clamping handle 264, and threads fit for the bolts are set inside the clamping handle 264. Two fitting parts 262 are symmetrically distributed on the worktable bracket 242 and fixedly conjugated with the worktable bracket 242 through one end, while the bolts 263 are fit for the threads in the clamping handle 264 respectively via the holes 2622 in the fitting parts 262. The fitting parts 262 further have the fitting surface 2621 fit for the bracket shaft 261, wherein the fitting surface 2621 is arc-shaped and has the same hub with the bracket shaft 261.

When releasing the clamping handle 264, a certain clearance is left between the fitting surface 2621 of the fitting part 262 and the bracket shaft 261, namely, the two portions are not contacted, thus the worktable bracket 242 can freely rotate around Axis Y relative to the machine tool bracket 241; when tightening the clamping handle 264, the fitting surface 2621 of the fitting part 262 is closely contacted with the bracket shaft 261, as a result, the worktable bracket 242 is fixed relative to the machine tool bracket 241.

The free rotation of the worktable bracket 242 around Axis Y relative to the machine tool bracket 241 permits the first worktable 251 and the second worktable 252 to support the workpiece at any location, but a horizontal or vertical location is commonly used. Therefore, a second positioning device 28 is set between the machine tool bracket 241 and the worktable bracket 242. As shown in FIGS. 9 and 10, the second positioning device 28 includes the first stop block 281 and the stop blocks 282a, 282b, 282c, wherein the first stop blocks can be set on either the machine tool bracket 241 or the worktable bracket 242, the second stop blocks can be set one either the machine tool bracket 241 or the worktable bracket 242, and the first stop block moves between the location fit for the second stop blocks and the location deviating from the second stop blocks.

In this embodiment, it is required to determine the first worktable 151 in 0° (in working location, in horizontal direction), 90° (in working location, in vertical direction) or 180° (not in working location, in horizontal direction) location, so three second stop blocks 282a, 282b, 282c are used respectively to determine the 0°, 90° and 180° location of the first worktable 151. When the first worktable 151 is in 180° location, the second worktable 152 is just at 0°. Alternatively, more or fewer second stop blocks can be set if needed.

The first stop block 281 is positioning block that can be pivoted on the machine tool bracket 241 through pin axis 283, and the second stop blocks 282a, 282b, 282c are fixed on the worktable bracket 242 at an included angle of 90° respectively. The second stop blocks 282a, 282b, 282c can alternatively fit for the first stop block 281 with the rotation of the worktable bracket 242.

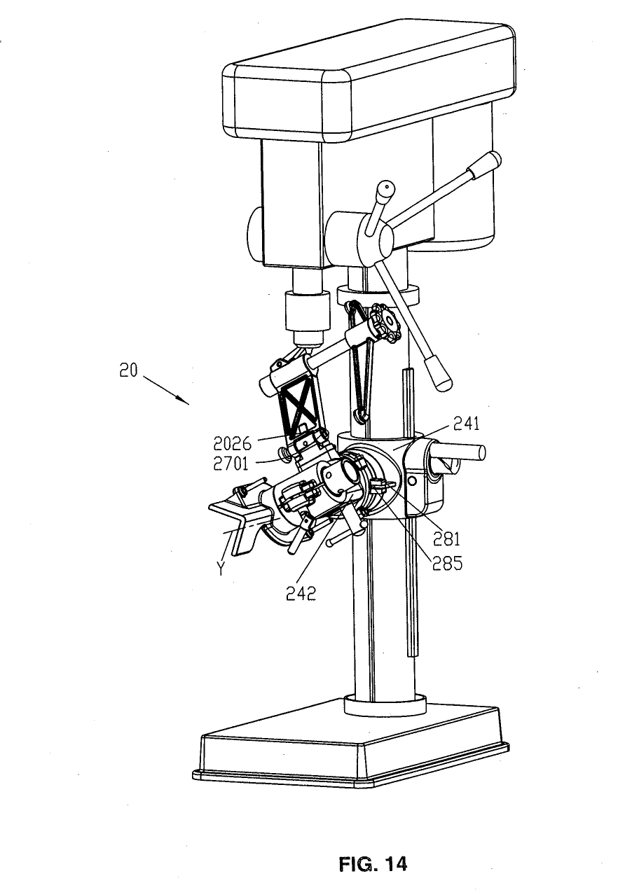

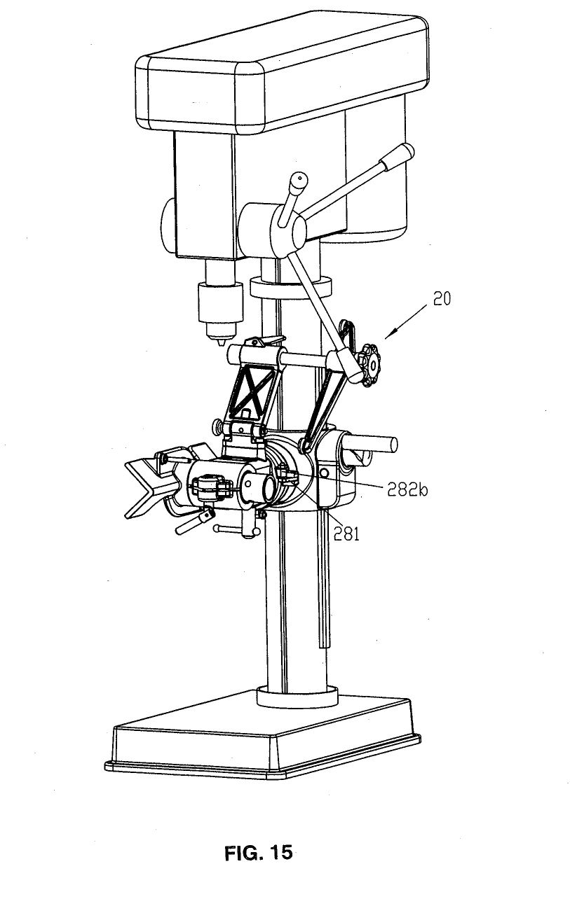

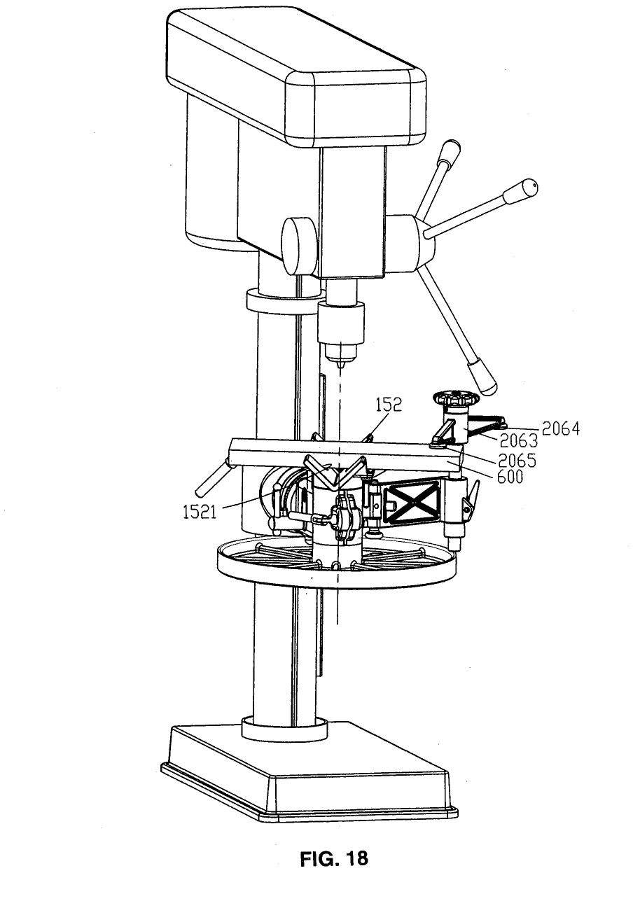

The first stop block 281 can also alternatively fit or unfit for the second stop blocks 282a, 282b, 282c through pivotal rotation. As shown in FIG. 9, the second stop blocks 282a, in coordination with the positioning block 281, determine the working location of the first worktable 151 in horizontal direction; as shown in FIG. 14, the positioning block 282 deviates from the second stop blocks 282a, 282b, 282c for fitting after pivotal rotation so that the worktable bracket 242 can freely rotate around Axis Y at the maximum angle of 360°; as shown in FIG. 15, the second stop block 282b, in coordination with the positioning block 281, determines the working location of the first worktable 151 in vertical direction; as shown in FIG. 18, the second stop block 282c, in coordination with the positioning block 281 (not shown in the figure), determines the working location of the second worktable 152 in horizontal direction, namely, the location of the first worktable 151 at 180°.

During utilization, the operator may also need to machine some inclined holes. To determine the rotation angle of the worktable bracket 242 relative to the machine tool bracket 242, the drill press also has a displaying device 284 for confirmation. As shown in FIGS. 9 and 14, the displaying device 284 includes a pointer 285 fixed on the machine tool bracket 241 and a dial 286 fit for the pointer 285, wherein the dial 286 is mounted on the worktable bracket 242. The pointer can also be set on the worktable bracket and the dial is configured on the machine tool bracket so as to determine the rotation angle of the worktable bracket 242 relative to the machine tool bracket 242. In this embodiment, the pointer 285 is set beneath the first stop block 281. When the first stop block 281 pivots until it is unfit for the second stop blocks, the pointer 285 is shown and is used to determine the rotation angle of the worktable bracket 242 relative to the machine tool bracket 242 in coordination with the dial 286.

Certainly, some special angles may also be used such as 15°, 30° or 45°. An auxiliary positioning device can also be set between the machine tool bracket 141 and the worktable bracket 242. Details are not given herein.

During machining, for safety consideration, the workpiece has to be clamped onto the worktable, so the drill press also has a clamping device 20. However, to allow the clamping device 20 to rotate relative to the machine tool bracket 241 with the worktable assembly 15 together and when the workpiece shall be machined at inclined angle, the clamping device can be conveniently used to clamp the workpiece. As shown in FIGS. 10 and 14, the clamping device 20 is conjugated on the worktable bracket 242.

The clamping device 20 includes the conjugated portion 201, the rotating bracket 202 pivoted on the conjugated portion, screw stem 203 glidingly set on the rotating bracket 202, the toggle 204 pivoted on the rotating bracket 202, the spring 205 set between the toggle 204 and screw stem 203, and the arm 206 conjugated on the screw stem 203 for the clamping workpiece.

The conjugated portion 201 is fixedly conjugated on the worktable bracket 242 through bolts, and has conjugated post 2011 conjugated with the rotating bracket 202.

The rotating bracket 202 can be conjugated onto the conjugated portion 201 via the pin axis 207 in a pivoted manner. The rotating bracket 202 has the first end conjugated with the conjugated portion 201 and the second end oppositely set, wherein the second end is provided with a trough hole for containing the screw stem 203, the first end of the rotating bracket 202 has the upper and lower ends; and the middle portion 2021 between the two ends; and the containing space 2022 between the upper and lower ends. The upper and lower through holes (no reference number given) for containing the pin axis 207 are set in the upper and lower ends.

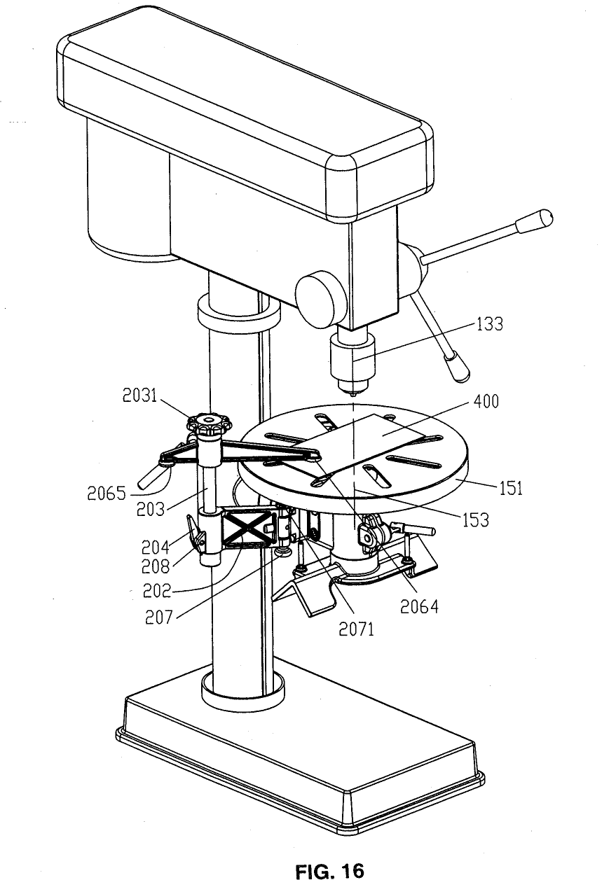

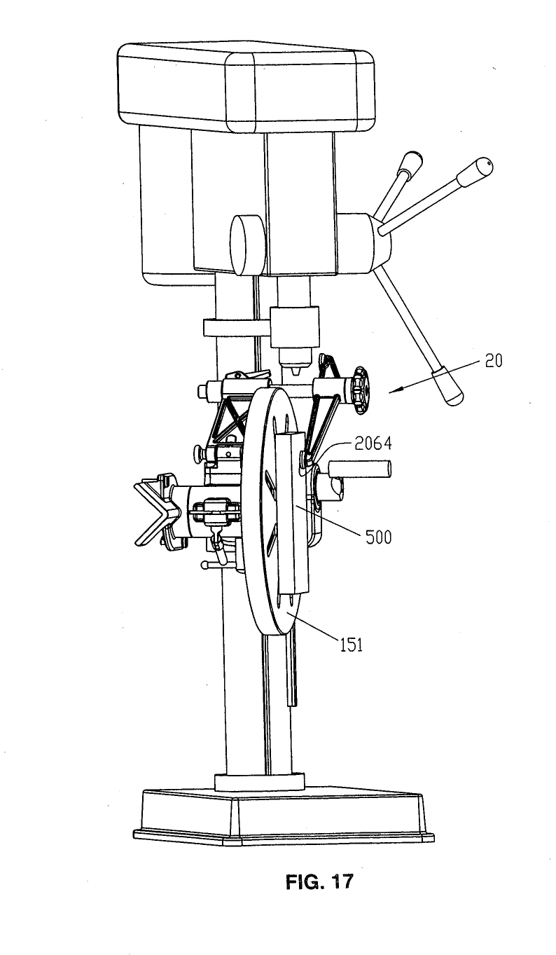

To allow the clamping device 20 to be suitable for the first worktable 151 and second worktable 152 simultaneously, the clamping device 20 has two locations: in the first location, the clamping device 20 is fit for the first worktable 151 to form the first holding area for clamping workpiece (as shown in FIGS. 16 and 17); in the second location, the clamping device 20 is fit for the second worktable 152 to form the second holding area for clamping workpiece (as shown in FIG. 18).

In this way, the clamping device 20 is required to be conveniently removed and assembled.

Therefore, a hole 2073 is set in the pin axis 207, the steel ball 2071 is installed in the hole 2073 and protrudes from the hole 2073 but links the hole 2073. A spring 2072 is set between the steel ball 2071 and the pin axis 207. The spring 2072 drives the steel ball 2071 to move towards the direction away from the hole 2073 all the time.

During assembly, the upper and lower ends of the rotating bracket 201 are stuck onto the conjugated post 2011 to allow it to be in the containing space 2022. Afterwards, the pin axis 207 is inserted into the upper and lower through holes simultaneously and set in the through hole of the conjugated post 2011. The steel ball 2071 under the action of the spring force of the spring 2072 enables the protruding hole 2073 to contact the surface 2026 of the upper end, thus the rotating bracket 202 is pivoted on the worktable bracket 242. In this way, the clamping device 20 can rotate around Axis a that is parallel to Axis Z as desired.

During removal, it is only required to pull the pin axis 207 and compress the steel ball 2071 and the spring 2072 so that the steel 2071 deviates from the surface 2026 for fitting. For working in reverse direction, re-assemble the device according to the steps above as per the demand.

Certainly, if the operator does not need the clamping device 20, it is only required to pull the pin axis 207 and compress the steel ball 2071 and the spring 2072 so that the steel 2071 deviates from the surface 2026 for fitting. In this way, the whole clamping device 20 can be removed, leading to convenient removal and saving more space.

A positioning mechanism is further mounted between the rotating bracket 202 and conjugated portion 201. The positioning mechanism is composed of a containing slot 2023 on the rotating bracket 202, and a spring 2024 and steel ball 2025 respectively contained in the containing slot 2023. A positioning slot for containing the steel ball 2025 is set on the conjugated post 2011 (not shown in the figure). The spring 2024 compresses the steel ball 2025 to make it move towards the positioning slot all the time. When the steel ball 2025 is in the positioning slot, the rotating bracket 202 can be positioned relative to the conjugated portion 201, while the steel ball 2025 deviates from the positioning slot, the rotating bracket 202 can freely rotate through the communication with the conjugated portion 201.

The toggle 204 is set on the rotating bracket 202 rotatablely via the pin axis 208. It is provided with the upper end for operator's manipulation and the upper end oppositely set. The spring 205 is configured between the upper end and the screw stem 203; in the lower end, the thread 2041 fit for the screw stem 203 (not shown in the figure).

When the thread on the screw stem 203 is engaged with the thread 2041, the screw stem 203 is in the locking location and free from sliding up and down. Jiggling is required. The operator can turn the knob 2031 above the screw stem so as to adjust the height of the screw stem 203 through the engagement of the thread on the screw stem 203 and the thread 2041. For rapidly adjusting the height of the screw stem 203, the operator presses the upper end of the toggle 204 and compresses the spring 205 so that the thread 2041 on the toggle 204 deviates from the screw stem 203 engaged, thus the operator can make the screw stem 203 slide up and down freely in the through hole in the second end of the rotating bracket 202 via the knob 2031. When reaching the desired location, release the toggle 204, under the action of the spring force, the thread on the screw stem 203 is fit for the thread 2041 to lead to the screw stem 203 in locking location and free from sliding up and down freely.

By referring to FIG. 10 again, the arm 206 for clamping workpiece sleeved onto the screw stem 203 has the first end 2061, the second end 2062 and the connecting portion 2063 linking the both ends, wherein the first end 2061 is in alignment with the second end 2062. The first and second holding end faces 2064, 2065 parallel to the worktable assembly 15 for holding workpiece are respectively set on the first end 2061 and the second end 2062. An elastic cushion (not shown in the figure) is provided on the first and second holding end faces 2064, 2065, thus the workpiece may not be damaged while being held. Certainly, the first and second holding end faces 2064, 2065 can be also equipped with a hold-down device that can be movably conjugated with the first and second holding end faces 2064, 2065, thus the hold-down device can make adjustment automatically for obtaining better effect of workpiece clamping when the workpiece surface is not very even.

The connecting portion 2063 is cylindrical and has a through hole for containing the screw stem 203. The screw stem 203 and the through hole of the connecting portion 2063 is interference-fit, so the arm 206 can rotate relative to the screw stem 203. A retainer ring for preventing the up-down movement of the arm 206 (not shown in the figure) is provided on the screw stem 203, the arm 206 cannot make up-down movement relative to the screw stem 203. Therefore, the first and second holding end faces 2064, 2065 can rotate relative to the screw stem 203 for alternative performance.

As shown in FIG. 16, when the first worktable 151 is machining the workpiece in horizontal direction, the coordination between the second stop blocks 282a in the second positioning device 28 and the positioning block 281 can be used to determine the working location of the first worktable 151 in horizontal direction (as shown in FIG. 9), and the clamping mechanism 26 allows the worktable bracket 242 to be fixed relative to the machine tool bracket 241. Moreover, the coordination between the first positioning part 271 in the first positioning device 27 and the positioning slot 221 makes the machine tool bracket 241 fixed relative to the column 12, and the central axis 153 of the worktable aligns with the axis 133 of the drill bit.

Place a thin workpiece 400 on the first worktable 151 and in the middle of the worktable, the clamping device 20 is in the first location at this time, its first holding end face 2064 is as the holding face and forms the first holding area for clamping the workpiece 400 with the coordination with the first worktable 151.

During operation, the operator can rapidly adjust the height of the screw stem 203, as shown in FIG. 10, press the toggle 204 and compress the spring 205 so that the screw stem 203 deviates from the thread 2041 engaged, thus the operator can make the screw stem 203 slide up and down freely in the through hole in the second of the rotating bracket 202 by operating the knob 2031. When reaching the desired location, release the toggle 204, under the action of the spring force, the thread on the screw stem 203 is fit for the thread 2041 to lead to the screw stem 203 in locking location. As a result, the first holding end face 2064 fixes the workpiece 400 onto the first worktable 151, thus the operator can machine the workpiece. For machining a thick workpiece, the operator can make the workpiece clamped through joggle.

As shown in FIG. 17, when the first worktable 151 is machining a workpiece in vertical direction, first loosen the clamping handle 264 so that a certain clearance is left between the fitting surface 2621 of the fitting part 262 and the bracket shaft 261. In this way, the worktable bracket 242 can rotate freely around Axis Y relative to the machine tool bracket 241 (as shown in FIG. 13). At this time, the clamping device 20 can rotate along with the worktable bracket 242; afterwards, the coordination between the second stop block 282b in the second positioning device 28 and the positioning block 281 is used to determine the working location of the first worktable 151 in vertical direction (as shown in FIG. 15, wherein the first worktable is not shown). Then tighten the clamping handle 264 so that the worktable bracket 242 is fixed relative to the machine tool bracket 241.

Place a workpiece 500 on the first worktable 151, the first holding end face 2064 of the clamping device 20 is as the holding face and forms the first holding area for clamping the workpiece 500 with the coordination with the first worktable 151.

As shown in FIG. 18, when the second worktable 152 is machining a workpiece in the horizontal direction, first loosen the clamping handle 264 so that certain clearance is left between the fitting surface 2621 of the fitting part 262 and the bracket shaft 261. In this way, the worktable bracket 242 can rotate freely around Axis Y relative to the machine tool bracket 241 (as shown in FIG. 13). At this time, the clamping device 20 can rotate along with the worktable bracket 242; afterwards, the coordination between the second stop block 282c in the second positioning device 28 and the positioning block 281 is used to determine the location of the first worktable 151 at 180°, namely, the working direction of the second worktable 152 in horizontal direction. Then tighten the clamping handle 264 so that the worktable bracket 242 is fixed relative to the machine tool bracket 241.

Pull the pin axis 207 and compress the steel ball 2071 and the spring 2072 so that the steel 2071 deviates from the surface 2026 for fitting; and then insert the clamping device 20 into the upper, lower through holes and the through holes set in the conjugated post 2011 after 180°'s rotation. The steel ball 2071 under the action of the spring force of the spring 2072 enables the protruding hole 2073 to contact the surface 2026, thus the clamping device 20 is pivoted on the worktable bracket 242. In this way, the clamping device 20 is in the second location and forms the second holding area for clamping workpiece in coordination with the second worktable 152.

Place a workpiece 600 in the slot 1521 on the second worktable 152. The operator can rotate the connecting portion 2063 so as to make the second holding end face 2065 as the holding face. The second holding end face 2065 clamps the workpiece 600 on the second worktable 152 for machining, being very convenient for operation.

In this way, the operator can adjust the clamping device 20 to make it suitable for the first and second worktable 151, 152 according to demand. Certainly, the operator can also select the first holding end face 2064 or the he second holding end face 2065 as required.

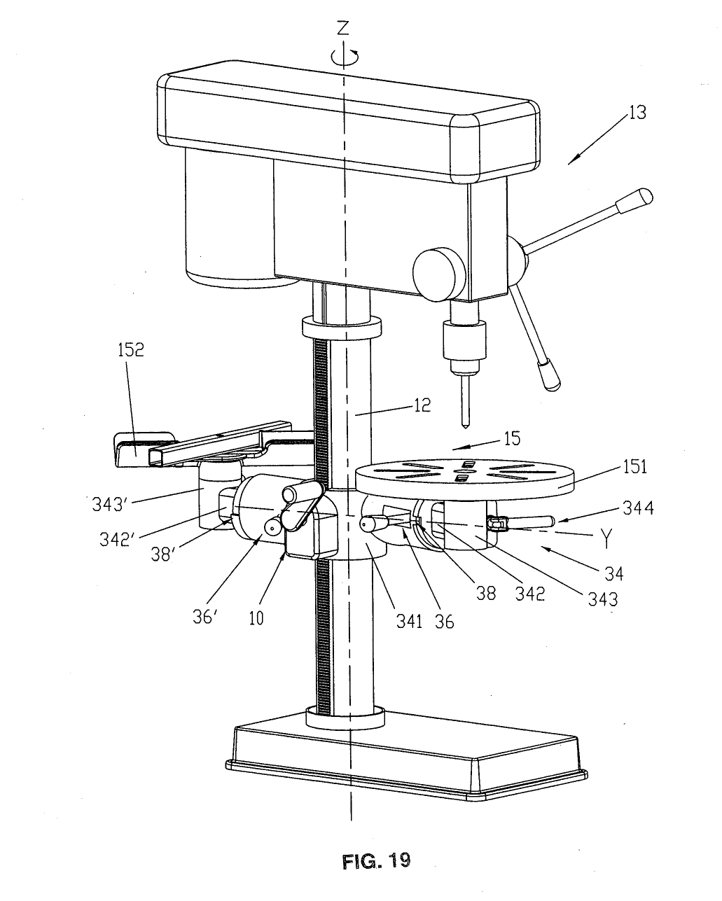

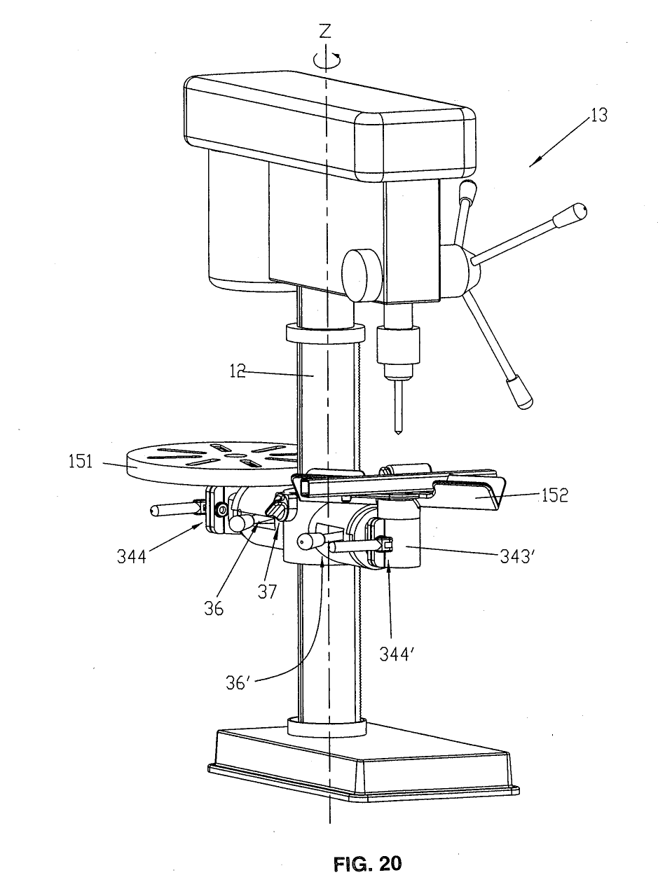

FIG. 19 and FIG. 20 show the third embodiment of the present invention. There are many components similar to those in Embodiment 1. The components with the same digits as displayed and described in Embodiment 1 are largely similar to those in Embodiment 1 in design, configuration and operation hereinafter; therefore, no further details are given for them. With the reference digits for components heading by “3” similar to those in Embodiment 1, different components are given for different digital identifications. The difference from Embodiment 1 is emphasized hereinafter.

As shown in FIG. 19, the worktable assembly 15 includes the first and second worktables 151, 152 in 180° layout relative to Axis Z, the rapid position-changing device 34 comprises the worktable brackets 342, 342′ on the machine tool bracket 341 extended along Axis Y in two directions, wherein the extension ends are connected with the worktable brackets 343, 343′ respectively through the binding posts 343, 343′, and fixing devices 344, 344′ are mounted between the binding posts 343, 343′ and the worktable brackets 343, 343′; clamping mechanisms 36, 36′ and the second positioning devices 38, 38′ are set between the machine tool bracket 341 and worktable bracket 342, 342′, symmetrically relative to the column 12 on the left and right.

Identical to Embodiment 1 the machine tool bracket 341 can rotate around Axis Z relative to the column 12 and the first positioning device 37 is set between the bracket and the column 12. The structure of the fixing devices 344, 344′, clamping mechanisms 36, 36′ and the second positioning devices 38, 38′ is the same as those in Embodiment 1; details will not be given herein.

Certainly, the clamping mechanism, the first and second positioning devices as well we the clamping device in Embodiment 2 are also applied to this embodiment.

As shown in FIG. 19, the conventional first worktable 151 is as workpiece supporting surface, as shown in FIG. 20, the V-shaped second worktable 152 is as the surface supporting workpiece. Therefore, it is only required to rotate the worktable relative to Axis Z so that the first and second worktables 151, 152 can alternatively function as the workpiece supporting plane. In this way, the operator can operate the equipment in a convenient, timesaving and laborsaving manner due to the sparing of V-shaped tooling removal.

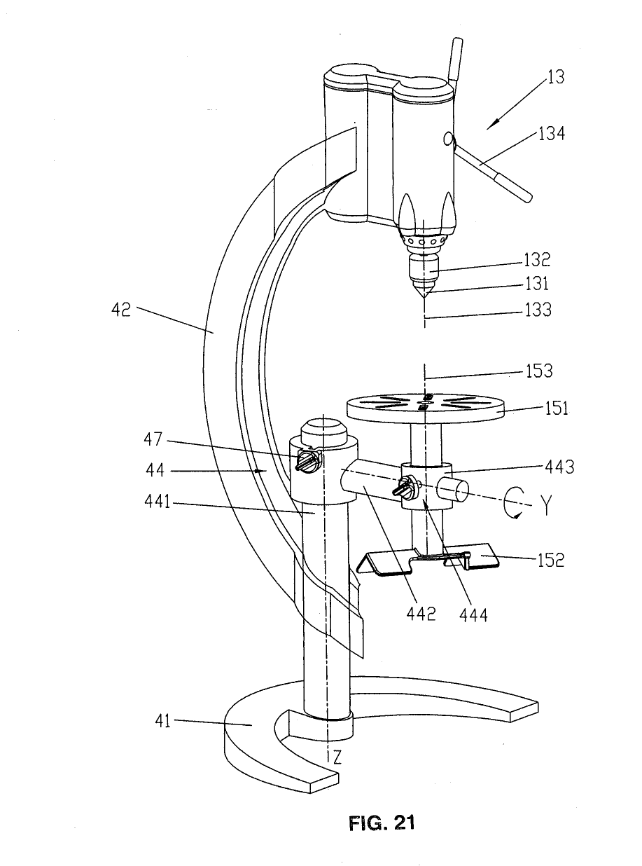

FIG. 21 shows the fourth embodiment of the present invention. There are many components similar to those in Embodiment 1. The components with the same digits as displayed and described in Embodiment 1 are largely similar to those in Embodiment 1 in design, configuration and operation hereinafter; therefore, no further details are given for them. With the reference digits for components heading by “4” similar to those in Embodiment 1, different components are given for different digital identifications. The difference from Embodiment 1 is emphasized hereinafter.

The column 42 is a C-shaped mechanism. The rapid position-changing device 44 includes the machine tool bracket 441 extended along Axis Z, the worktable bracket 442 on the machine tool bracket 441 and extended along Axis Y perpendicular to Axis Z, and the binding post 443 rotatablely conjugated with the worktable bracket 442, thus the binding post 443 can rotate around Axis Y, while the fixing device 444 is set between the worktable bracket 442 and the binding post 443. The structure of the fixing device 444 is different from that in Embodiment 1. It mainly uses the conventional bolt locking structure. Details are not given herein any further. Certainly, when the binding post 443 is relative to the worktable bracket 442, the drill press is further provided with a scale indication device identical to that on the conventional drill press; the details are also not given herein. The column 42 is conjugated onto the C-shaped base 41 through the machine tool bracket 441. Obviously, the column 42 can be directly set on the base 41, while the machine tool bracket 441 is directly set on the column 42 (not shown in the figure). In this embodiment, the first and second worktables 151, 152 are in 180° layout relative to Axis Y and linked each other through the binding post 443. Certainly, the first and second worktables 151, 152 can also rotate relative to the central axis 153 as required. For adjusting the height of the worktables, a lifting device (not shown in the figure) similar to that in Embodiment 1 and the first positioning device 47 similar to that in Embodiment capable realizing positioning and locking functions are set between the machine tool bracket 441 and worktable bracket 442. The structure is detailed herein further. When the binding post 443 is driven to rotate around Axis Y, the first and second worktables 151, 152 can also be driven to rotate around Axis Y, thus the first or the second worktable 151, 152 can be selected through the rapid position-changing device 44 according to the workpiece profile as workpiece supporting plane. In this way, the operator can operate the equipment in a convenient, timesaving and laborsaving manner due to the sparing of V-shaped tooling removal.

Certainly, the clamping mechanism, the first and second positioning devices and the clamping device in Embodiment 2 are also applied to this embodiment.

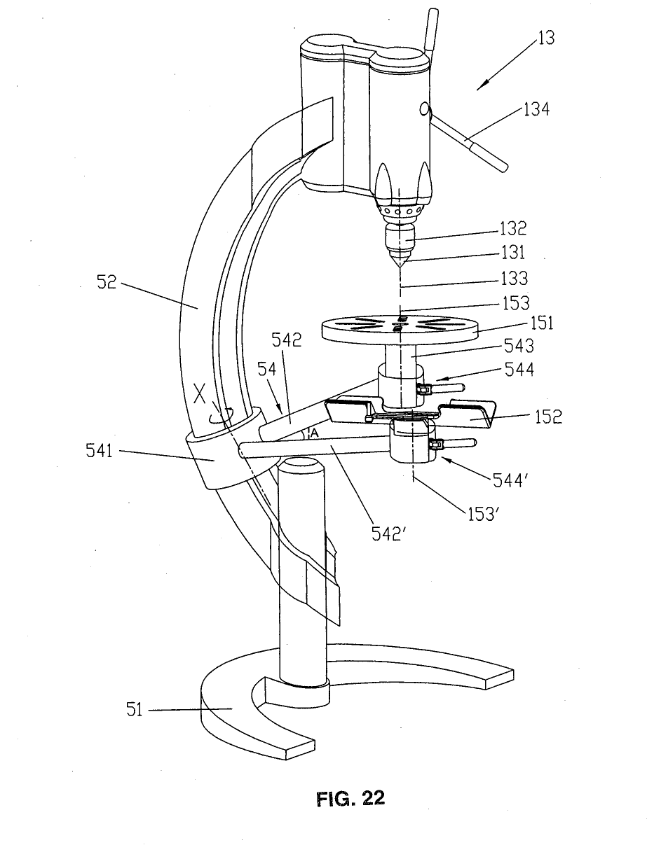

FIG. 22 shows the fifth embodiment of the present invention. There are many components similar to those in Embodiment 4. The components with the same digits as displayed and described in Embodiment 4 are largely similar to those in Embodiment 4 in design, configuration and operation hereinafter; therefore, no further details are given for them. With the reference digits for components heading by “5” similar to those in Embodiment 1, different components are given for different digital identifications. The difference from Embodiment 1 is emphasized hereinafter.

The rapid position-changing device 54 includes the machine tool bracket 541 rotatablely conjugated on the column 52, and rotating axis X. The first and second worktable brackets 542, 542′ set on the machine tool bracket 54 have certain included angle. The first and second worktable bracket 542, 542′ are respectively conjugated with the first and second binding post 543, 543′, wherein the machine tool bracket 541 is provided with a bearing (not shown in the figure) device, thus the machine tool bracket 541 can rotate relative to the column 52; between the first, second binding post 543, 543′ and the first, second worktables 151, 152, the fixing device 544, 544′ are configured, wherein the fixing device 544, 544′ have the same structure as that in Embodiment 1 and can permit the first and second worktables 151, 152 to rotate relative to the respective axes 153, 153′, or to adjust the relative height between the first, second worktables 151, 152 and the first, second worktable bracket 542, 542′.

When the machine tool bracket 541 is forced to rotate around the rotating axis X, the first and second worktable brackets 542, 542′ are driven to rotate, thus the first and second worktables 151, 152 can rotate around Axis X. In this way, the first worktable 151 or the second worktable 152 can be selected through the rapid position-changing device 54 according to the workpiece profile as workpiece supporting plane. Therefore, the operator can operate the equipment in a convenient, timesaving and laborsaving manner due to the sparing of V-shaped tooling removal.

Certainly, the clamping mechanism, the first and second positioning devices and the clamping device in Embodiment 2 are also applied to this embodiment.

The abovementioned embodiments are preferred embodiments provided for the technicians skilled in this art to have a better understanding of the present invention. However, the present invention is not limited by the embodiments above. Any improvement may be easily thought up by persons skilled in this art is within the scope of the design concept of the present invention.

1. A drill press, comprising a base, a column conjugated with the base, a headstock conjugated with the column, wherein the headstock includes a power device and a drill bit driven to rotate by the power device, characterized in that the drill press further comprises the first and second worktables, a rapid position-changing device is mounted between the first and second worktables, the rapid position-changing device can alternatively adjust the first and second worktables in a rapid way.

2. The drill press as claimed in claim 1, characterized in that one of the first and second worktables is V-shaped worktable, and a slot for containing workpiece is set in the middle of the V-shaped worktable.

3. The drill press as claimed in claim 1, characterized in that the rapid position-changing device includes a machine tool bracket extended from the column or 1/2 location of the base, worktable brackets conjugated with the machine tool bracket and a binding post set between the worktable brackets and the first, second worktables, at least one of the connections between the machine tool bracket and column, worktable brackets and machine tool bracket as well as the binding post and worktable brackets is flexibly conjugated so that the first and second worktables can be rapidly adjusted to the working location.

4. The drill press as claimed in claim 3, characterized in that the column extends along Axis Z, the machine tool bracket movably conjugated on the column, the worktable brackets are set on the machine tool bracket and extends along Axis Y direction perpendicular to Axis Z, and the first and second worktables can rotate either Axis Y or Axis Z.

5. The drill press as claimed in claim 4, characterized in that the first and second worktables are in 180° layout relative to Axis Y.

6. The drill press as claimed in claim 4, characterized in that the first and second worktables are in 180° layout relative to Axis Z.

7. The drill press as claimed in claim 3, characterized in that the machine tool bracket is conjugated on the column or the base and extends along Axis Z, the worktable brackets are set on the machine tool bracket and extends along Axis Y direction perpendicular to Axis Z, the binding post can rotatably conjugated on the worktable brackets, the first and second worktables can rotate around Axis Y.

8. The drill press as claimed in claim 7, characterized in that the first and second worktables are in 180° layout relative to Axis Y.

9. The drill press as claimed in claim 3, characterized in that the column is in special shape, the machine tool bracket rotatably conjugated on the column and has the rotating axis X, the first and second worktable brackets are set on the machine tool bracket and have certain included angle, the first and second worktables can rotate around Axis X.

10. The drill press as claimed in claim 3, characterized in that a clamping mechanism for fixing the relative location of worktable bracket and machine tool bracket is mounted between the worktable bracket and the machine tool bracket.

11. The drill press as claimed in claim 10, characterized in that the clamping mechanism includes the eccentric wheel pivoted on the machine tool bracket, the connecting part linking the eccentric wheel and the worktable bracket, wherein the eccentric wheel has two locations, in the first location, the worktable bracket is fixed relative to the machine tool bracket; in the second location, the worktable bracket can rotate relative to the machine tool bracket.

12. The drill press as claimed in claim 10, characterized in that the clamping mechanism includes the bracket shaft set on the machine tool bracket, fitting part on the worktable bracket and the locking device, wherein the locking device drives the fitting part to move between the location closely contacting the bracket shaft and the location keeping away from it, in closely contacting location, the worktable bracket is fixed relative to the machine tool bracket; in out-of-touch location, the worktable bracket rotates relative to the machine tool bracket.

13. The drill press as claimed in claim 3, characterized in that the first positioning device for fixing the relative location of the machine tool bracket and column is configured between the column and the machine tool bracket.

14. The drill press as claimed in claim 13, characterized in that the first positioning device includes the first positioning part movably set on the machine tool bracket and the positioning slot set on the column, wherein the first positioning part moves between the location containing the positioning slot and the location deviating from the positioning slot.

15. The drill press as claimed in claim 14, characterized in that the machine tool bracket is provided with a containing slot extended along vertical axis, at least a portion of the first positioning part is contained in the containing slot, the first positioning device further includes a releasing device which operates the first positioning part to move along the vertical axis and moves between the location containing the positioning slot and the location deviating from the positioning slot.

16. The drill press as claimed in claim 15, characterized in that the releasing device includes a positioning handle rotatably conjugated on the machine tool bracket, and an elastic element between the positioning handle and the first positioning part, wherein the positioning handle drives the first positioning part to move along vertical axis direction.

17. The drill press as claimed in claim 16, characterized in that the releasing device further includes a positioning pin set between the positioning handle and the elastic element, the end face of the positioning handle has an inclined face and the positioning pin can slide along the inclined surface.

18. The drill press as claimed in claim 3, characterized in that a second positioning device for fixing the relative location of the worktable bracket and the machine tool bracket is provided between the worktable bracket and the machine tool bracket.

19. The drill press as claimed in claim 18, characterized in that the second positioning device including the first stop block and the second stop block, wherein the first stop block is set on either the machine tool bracket and the worktable bracket, the second stop block is mounted on the other one of either machine tool bracket or worktable bracket, the first stop block moves between the location fit for the second stop block and the location deviating from the second stop block for fitting.

20. The drill press as claimed in claim 19, characterized in that the first stop block is fixed on the worktable bracket, the second stop block is fixed on the machine tool bracket, wherein the first stop block is alternatively fit for the second stop block along with the rotation of the worktable bracket.

21. The drill press as claimed in claim 19, characterized in that the first stop block can movably set on the worktable bracket, the second stop block is fixed on the machine tool bracket, wherein the first stop block is alternatively fit for the second stop block.

22. The drill press as claimed in claim 19, characterized in that the first stop block is rotatably set on the machine tool bracket, the second stop block is fixed on the worktable bracket, wherein the first stop block is alternatively fit for the second stop block.
